(19) United States
(12) Patent Application Publication
(10) Pub. No.: US 2003/0229695 A1
(43) Pub. Date: Dec. 11, 2003

(54) System for use in determining network operational characteristics

(76) Inventor: Edmund Joseph Mc Bride, Lansdale, PA (US)

Correspondence Address: Alexander J. Burke, SIEMENS CORPORATION, 170 WOOD AVENUE SOUTH, ISELIN, NJ, 08830, US

(21) Appl. No.: 10/388,045

(22) Filed: Mar. 13, 2003

Related U.S. Application Data
(60) Provisional application No. 60/366,507, filed on Mar. 21, 2002.

(51) Int. Cl. G06F 9/45; G06F 15/173

(52) U.S. Cl. 709/224; 703/22

(57) ABSTRACT

A system, method, and computer product are adapted for providing network operational characteristics of a software application. Functions of a software application are performed in a test network responsive to identifying the functions of the software application. The network operational characteristics, for example bandwidth and latency, of the software application in the test network are analyzed, responsive to performing the functions of the software application in the test network, to estimate network operational characteristics of the software application in a production network.

### CROSS-REFERENCE TO RELATED APPLICATIONS

The present application is a non-provisional application of provisional application having serial No. 60/366,507 by Ed McBride filed on Mar. 21, 2002. The present application is also related to non-provisional applications having Ser. Nos. 10/349,054 and 10/348,740 by Ed McBride filed on Jan. 22, 2003.

### FIELD OF THE INVENTION

The present invention generally relates to computer networks. More particularly, the present invention relates to a system, method, and computer product, for use in determining network operational characteristics of a software application.

### BACKGROUND OF THE INVENTION

Network capacity planning is a process of measuring a networks ability to serve content to its users at an acceptable speed. The process involves measuring the number of active users and by how much demand each user places on the server, and then calculating the computing resources that are necessary to support the usage levels.

Two key elements of network capacity performance are bandwidth and latency. Bandwidth is just one element of what a person perceives as the speed of a network. Another element of speed, closely related to bandwidth, is latency. Latency refers generally to delays in processing network data, of which there are several kinds. Latency and bandwidth are related to each other. Whereas theoretical peak bandwidth is fixed, actual or effective bandwidth varies and can be affected by high latencies. Too much latency in too short a time period can create a bottleneck that prevents data from “filling the pipe,” thus decreasing effective bandwidth. Businesses use the term Quality of Service (QoS) to refer to measuring and maintaining consistent performance on a network by managing both bandwidth and latency.

Prior network capacity systems, either analytical and/or discreet event simulation tools, import a limited amount of live application traffic patterns to drive a model of user's network configurations. To validate a pre-existing network traffic model, a network analyst needs to compare two simulation runs and spend considerable time adjusting the pre-existing simulated traffic patterns to match the network load of the imported live traffic patterns. The effort to perform this task is challenging and is not usually attempted. Importing production traffic patterns, using trace files, is limited with respect to time coverage. It would be very difficult to import a series of trace files covering all the peak hours of traffic activity over several weeks. It would also very difficult to identify and compare the simulated traffic with real production traffic in order to adjust the simulated patterns to allow for future simulation runs that can predict what affect new clients will have on network bandwidth requirements. Hence, using these tools for multiple applications is very time consuming, expensive and not usable by average individuals typically in the position to do network sizing and performance estimates. Accordingly, there is a need for a system, method, and computer product for use in determining network operational characteristics of a software application that overcomes these and other disadvantages of the prior systems.

### SUMMARY OF THE INVENTION

A system, method, and computer product are adapted for providing network operational characteristics of a software application. Functions of a software application are performed in a test network responsive to identifying the functions of the software application. The network operational characteristics, for example bandwidth and latency, of the software application in the test network are analyzed, responsive to performing the functions of the software application in the test network, to estimate network operational characteristics of the software application in a production network.

These and other aspects of the present invention are further described with reference to the following detailed description and the accompanying figures, wherein the same reference numbers are assigned to the same features or elements illustrated in different figures. Note that the figures may not be drawn to scale. Further, there may be other embodiments of the present invention explicitly or implicitly described in the specification that are not specifically illustrated in the figures and visa versa.

### BRIEF DESCRIPTION OF THE DRAWINGS

FIG. 1 illustrates a network, including a server electrically coupled to a plurality of client/workstations, in accordance with a preferred embodiment of the present invention.

FIG. 2 illustrates a process for determining network load employed by one or more applications concurrently operating in the network, as shown in FIG. 1, in accordance with a preferred embodiment of the present invention.

FIG. 3 illustrates a timing diagram for an application baseline profile in a test network, as shown in FIG. 1, in accordance with a preferred embodiment of the present invention.

FIG. 4 illustrates a method for determining the application baseline profile, using the timing diagram shown in FIG. 3, in accordance with a preferred embodiment of the present invention.

FIG. 5 illustrates a logical diagram of the network guidelines estimator, as shown in FIG. 1, in accordance with a preferred embodiment of the present invention.

FIG. 6 illustrates a method for estimating a network load for an application operating in a test network, as shown in FIG. 1, using the network guidelines estimator, as shown in FIG. 1, in accordance with a preferred embodiment of the present invention.

### DETAILED DESCRIPTION OF THE PREFERRED EMBODIMENTS

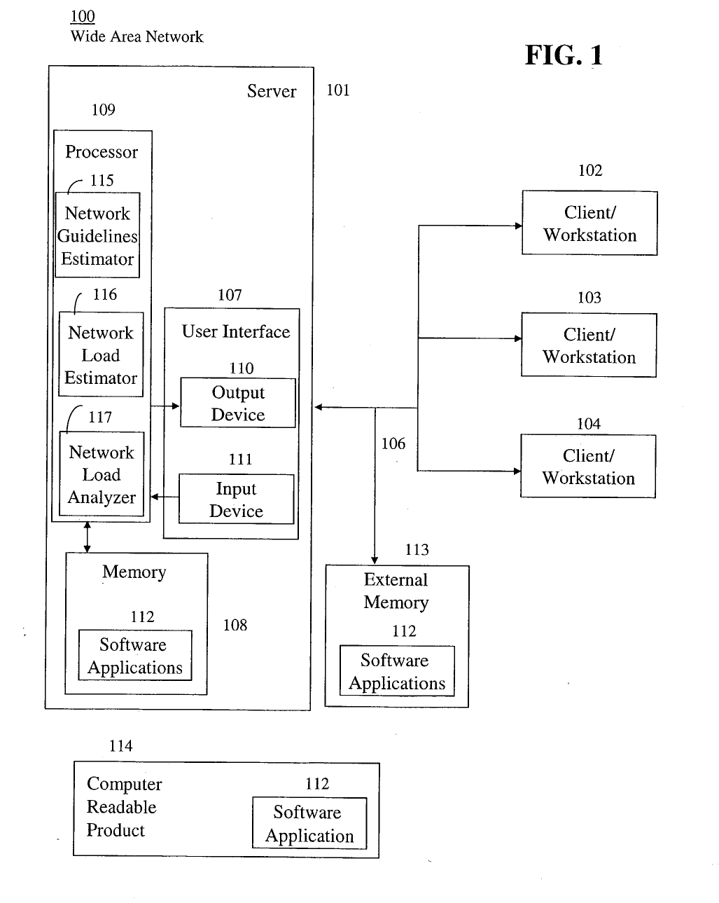

FIG. 1 illustrates a network 100, including a server 101 electrically coupled to a plurality of client/workstations 102, 103, and 104 via a communication path 106, in accordance with a preferred embodiment of the present invention.

The network 100, otherwise called a computer network or an area network, may be implemented in many different shapes and sizes. Examples of networks 100 include, without limitation and in any combination, a Local Area Network (LAN), a Wide Area Network (WAN), a Metropolitan Area Network (MAN), a Storage Area Network (SAN), a System Area Network (SAN), a Server Area Network (SAN), a Small Area Network (SAN), a Personal Area Network (PAN), a Desk Area Network (DAN), a Controller Area Network (CAN), a Cluster Area Network (CAN). Hence, the network 100 may have any number of servers 101 electrically coupled to any number of client/workstations 102, 103, and 104 over any type of communication path 106 over any distance. Preferably, the network 100 is a WAN.

Generally, network descriptions, such as LAN, WAN, and MAN, imply the physical distance that the network spans or a distance-based concept. However, present and anticipated technology changes, via the Internet, intranet, extranet, virtual private network, and other technologies, now imply that distance is no longer a useful differentiator between the various networks. However, for the sake of consistency, these other types of network also became known as various types of networks.

For example, a LAN connects network devices over a relatively short distance. A networked office building, school, or home usually contains a single LAN, though sometimes one building will contain a few small LANs, and occasionally a LAN will span a group of nearby buildings. In Internet Protocol (IP) networking, one can conceive of a LAN as a single IP subnet (though this is not necessarily true in practice). Besides operating in a limited space, LANs typically include several other distinctive features. LANs are typically owned, controlled, and managed by a single person or organization. They also use certain specific connectivity technologies, primarily Ethernet and Token Ring.

Further, by example, a WAN spans a large physical distance. A WAN implemented as the Internet spans most of the world. A WAN is a geographically dispersed collection of LANs. A network device called a router connects LANs to a WAN. In IP networking, the router maintains both a LAN address and a WAN address. WANs typically differ from LANs in several ways. Like the Internet, most WANs are not owned by any one organization but rather exist under collective or distributed ownership and management. WANs use technology like leased lines, cable modems, Internet, asynchronous transfer mode (ATM), Frame Relay, and X.25 for connectivity. A WAN spans a large geographic area, such as a state, province, or country. WANs often connect multiple smaller networks, such as LANs or MANs. The most popular WAN in the world today is the Internet. Many smaller portions of the Internet, such as extranets, are also WANs. WANs generally utilize different and much more expensive networking equipment than do LANs. Technologies sometimes found in WANs include synchronous optical network (SONET), frame relay, and ATM.

The server 101 generally includes a user interface 107, a memory unit 108, and a processor 109. The memory unit 108 generally includes software applications (“applications”) 112. The user interface 107 generally includes an output device 110 and an input device 111.

The server 101 may be implemented as, without limitation, a computer, a workstation, a personal computer, a handheld computer, a desktop computer, a laptop computer, and the like. The server 101 may be mobile, fixed, or convertible between mobile and fixed, depending on the particular implementation. Preferably, the server 101 is a computer adapted for a fixed implementation.

The processor 109, otherwise called a central processing unit (CPU) or controller, controls the server 101. The processor 109 executes, retrieves, transfers, and decodes instructions over communication paths, internal or external to the server 101, that are used to transport data to different peripherals and components of the server 101. The processor 109 includes a network guidelines estimator (NGE) 115, a network load estimator (NLE) 116, and/or a network load analyzer (NLA) 117, or an interface to each of the same elements 115, 116, and 117 located outside the server 101, but communicating with the processor 109, such as via the communication path 106. Each of the elements 115, 116, and 117 may be employed in hardware, software, and a combination thereof. Preferably, each of the elements 115, 116, and 117 is individually employed in the same or different networks 100 at the same or different times, as describe in further detail herein.

The memory unit 108 includes without limitation, a hard drive, read only memory (ROM), and random access memory (RAM). The memory unit 108 is a suitable size to accommodate the applications 112, and all other program and storage needs, depending on the particular implementation. The applications 112, otherwise called executable code or executable applications, are preferably application specific provider (ASP) executable applications deployed over a WAN.

In the user interface 107, the input device 111 permits a user to input information into the server 101 and the output device 110 permits a user to receive information from the server 101. Preferably, the input device is a keyboard, but also may be a touch screen, a microphone with a voice recognition program, for example. Preferably, the output device is a display, but also may be a speaker, for example. The output device provides information to the user responsive to the input device receiving information from the user or responsive to other activity by the server 101. For example, the display presents information responsive to the user entering information in the server 101 via the keypad.

The server 101 may also contain other elements, well known to those skilled in the relevant art, including, without limitation, a data input interface and a data output interface providing communication ports that permit data to be received by and sent from, respectively, the server 101. The data input interface and the data output interface may be the same interface, permitting bidirectional communication, or different interfaces, permitting opposite, unidirectional communication. Examples of the data input interface and the data output interface include, without limitation, parallel ports, and serial ports, such as a universal serial bus (USB). Each of the elements 115, 116, and 117 may communicate with the server 101 using the data input interface and the data output interface, when the elements 115, 116, and 117 are located outside of the server 101.

Each of the client/workstations (“client”) 102, 103, and 104 may be implemented as, without limitation, a computer, a workstation, a personal computer, a handheld computer, a desktop computer, a laptop computer, and the like. Each of the clients 102, 103, and 104 may be mobile, fixed, or convertible between mobile and fixed, depending on the particular implementation. Preferably, each of the clients 102, 103, and 104 are adapted for a fixed implementation.

The communication path 106 electrically couples the server 101 to each of the clients 102, 103, and 104. The communication path 106 may be wired and/or wireless or accommodate the fixed and/or mobile server 101 or clients 102, 103, and 104, respectively. Examples of wired communication paths include, without limitation, LANs, leased WAN circuits, ATM, frame relay. Examples of wireless communication paths include, without limitation, wireless LANs, microwave links, satellite. Preferably, the communication path 106 is wired.

The network 100 may also include an external memory unit 113 for storing software applications 112. The external memory unit 113 may include, without limitation, one or more of the following: a hard drive, read only memory (ROM), and random access memory (RAM). The external memory unit 113 is a suitable size to accommodate the applications 112, and all other program and storage needs, depending on the particular implementation. The external memory unit 113 may be used in cooperation with or as a substitute for the memory unit 108 in the server 101, depending on the particular implementation of the server 101, and the network 100.

Computer readable product 114, preferably a computer readable storage medium, comprises a disk (such as a compact disk (CD), for example, or other portable storage medium containing the executable application 112 for insertion or downloading in memory unit 108 or external memory unit 113.

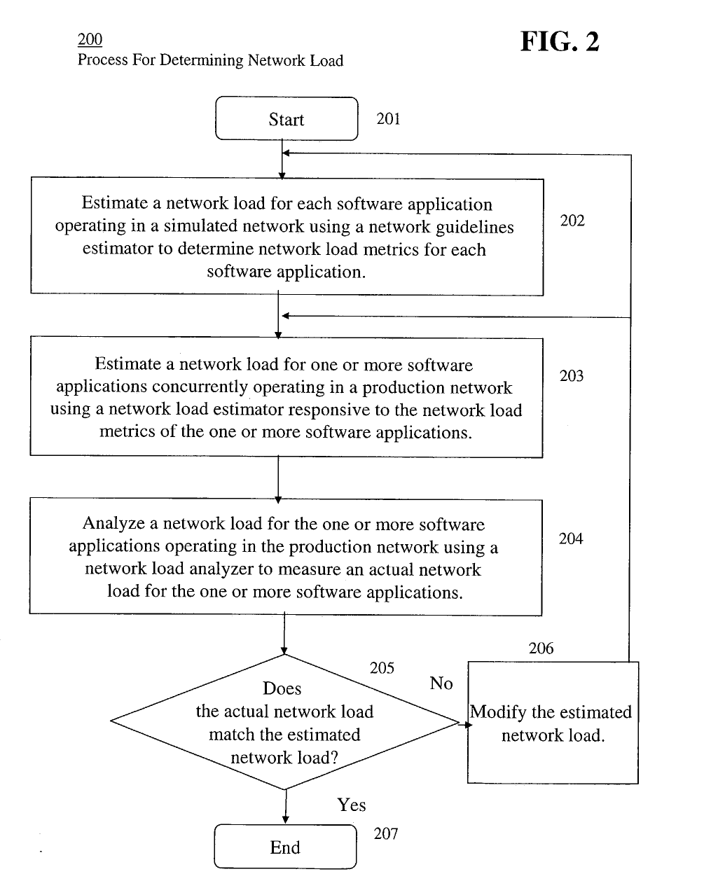

FIG. 2 illustrates a process 200 for determining network load employed by one or more applications 112 concurrently operating in the network 100, as shown in FIG. 1, in accordance with a preferred embodiment of the present invention.

The process 200, otherwise called a method, begins at step 201.

At step 202, the network guidelines estimator (NGE) 115, shown in FIG. 1, estimates a network load for each software application operating in a simulated network to determine network load metrics for each software application.

The delivery of an application 112 on a network 100 is typically successful when application's network behavior is reasonably characterized, especially for a WAN. The characteristics of the applications are determined by testing them in a controlled network environment, otherwise called a simulated or test network, to determine the application's network behavior. This process is called application network baseline profiling.

Preferably, application network baseline profiling is performed in a controlled test environment having the following conditions:

1. The server(s) 101 and the clients 102-104 are on a LAN.

2. The network traffic between all application components is visible on the LAN at a single network location when the client executes a function of the application 112.

3. One client (i.e., a test client) is using the server(s) 101.

Two network tools are used to perform the application network baseline profiling.

1. A conventional third party software tool, such as Application Expert™ tool, captures the application's network traffic when the test client executes application functions.

2. The NGE 115 uses information from Application Expert tool to calculate the application's network load and latency parameters and other metrics that profile the application's network behavior.

The following text under step 202 describes the process for profiling an application's network load characteristics, a process to profile an application's network latency performance, and a process to estimate a networks capacity requirements when deploying multiple user clients over a WAN responsive to the application's network load characteristics. The following description references the following definitions:

1. Concurrent users: Clients of the application that are active (i.e., generating network traffic) in any given predetermined (e.g., one-minute) time interval.

2. Active users: Number of clients that are logged on to the application at a given time using the system at an ordinary pace (i.e., executing functions, making on-line updates and selections, and reviewing and evaluating screen information, etc.).

3. Deployed users: Clients with the application installed.

4. Task: Individual application functions executed to accomplish a specific task (i.e., a sub-unit of work).

5. Work Unit: A sequence of tasks executed to complete a unit of work that the application was designed to accomplish. Applications generally have many types of work units.

The process for profiling an application's network load characteristics is described as follows. One characteristic of an application's network load is a load factor. The load factor is the calculation of the average network load that a user of a particular application generates while using an application. The load factor is calculated using the following information:

1. List of work units that users can execute when using an application.

2. List of tasks (i.e., application functions) that make up each work unit.

3. Frequency of use of each work unit, if this is practical to determine or estimate.

Preferably, at least 95% of the application's typical work units are tested in the test network, by capturing the network traffic generated while a test client executes each work unit. A separate capture file is saved for each work unit.

Testing involves measuring the network load placed on the LAN in the controlled laboratory environment using the conventional third party software tool. Preferably, a person (i.e., a test user) with experience in use of the application manually conducts the test to collect accurate measurements. Alternatively, the test may be performed automatically. The experienced user executes the work units at the approximate speed of a predicted end user, including computer processing time and user think time. The executed work units are used for profiling the work units to obtain a reasonable network load factor (LF) and a completion time for a work unit (i.e., the work unit completion time) (WCT). The application's network load factor and work unit completion time are also used by the NLE 116 to estimate how many user workstations can be deployed on a WAN, as described herein below.

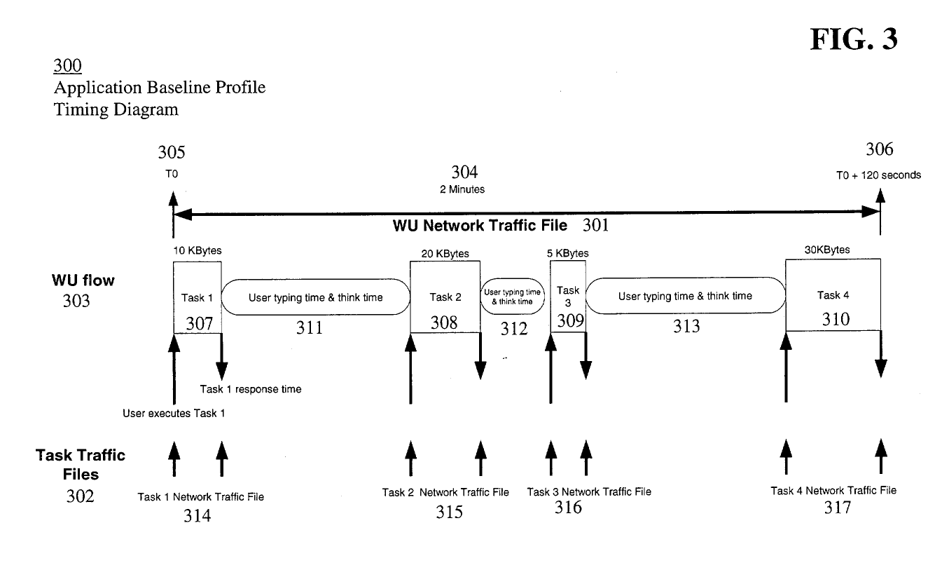

After the application is tested, the network traffic information stored in each work unit capture file 301 (discussed later in connection with FIG. 3) is imported into the NGE 115. The NGE then calculates the application's network load factor, which specifies the average amount of network capacity (i.e., bandwidth) used when a user is executing work units. The network load factor relates to the application's network load profile and how network friendly it is.

The NGE 115 uses the network load factor to determine a concurrency factor (CF), which specifies the maximum number of concurrent users a network can support before reaching some predetermined threshold capacity that identifies the limit or breakpoint of the network. For example, if a network has a recommended predetermined threshold capacity of 60% capacity and an application has a network load factor of 2%, the concurrency factor is 30 (i.e., 60% /2%). The concurrency factor indicates that 30 concurrent users will require 60% of the network capacity.

The NGE 115 uses the concurrency factor and the work unit completion time to estimate the total number of deployable clients that that a production network 100 can support. By accurately estimating the number of concurrent users that need to be accommodated during peak time, the network load information may be used to properly size and configure a production network 100.

The following text under step 202 describes the process for determining an application's network latency profile. Since tasks are sub-units of work, a user executing application tasks is sensitive to response time. For example, after a user presses the enter key to start the execution of a task, the user may be expecting a completed response within two seconds. If the user's workstation 102-104 is on the same LAN that the server 101 is on, the response may come back in one second. Most of this time would be server 101 and workstation 102-104 processing time. Very little of this time would be due to the network latency (NL) of the LAN. However, if the user's workstation 102-104 is separated from the server 101 by a WAN, network latency can contribute to a significant delay. An application's performance characteristics can be determined, by testing the application tasks and by using the NGE 115 to profile the application's network latency metrics.

Three components to latency that comprise network response delay include:

1. Insertion or Transmission Delay—caused by the speed of the LAN or WAN.

2. Propagation Delay—dictated by the distance data has to travel over the network.

3. Queue Delay—Delay due to congestion from sharing a network among multiple users. This is why a network needs a predetermined capacity threshold.

To profile an application's network latency characteristics, the conventional third party software tool individually tests each task executed when testing the work units. During these tests, the network traffic generated is captured in a network trace file, wherein there is one network trace file for each task. The network trace files are imported into the NGE 115, which calculates the parameters that produce the application's average network latency metric. The NGE 115 also produces a detailed listing of each task identifying the task's specific network latency.

The NGE 115 also provides latency parameters that are imported into the NLE 116, which is used to estimate the aggregate effect on one application 112 when sharing a network 100 with additional applications 112. The following parameters are averages over all tested tasks.

1. Average task traffic size in bytes.

2. Average number of request/response pairs. These are called application turns that interact with a WAN's propagation delay (i.e., distance). Any application task that has a large number of turns suffers large network latencies, which cannot be reduced by increasing the WAN's bandwidth (speed).

3. Average size of the data frames used to send data over the network.

4. Application workload and estimating workstation deployment.

The following text under step 202 describes the process to estimate a network's capacity requirements when deploying multiple clients over a WAN, otherwise called workload. The term workload refers to the number of work units (WU) completed in a predetermined (e.g., one hour) time period (i.e., a peak hour). The NGE 115 calculates a metric called the application's work unit completion time (WCT). The work unit completion time is an average value of all WUs tested, which is adjusted to a 95% confidence value based on the variance of all work units tested.

To estimate, on average, the maximum number of WUs completed in one hour, when each one-minute interval has, on average, one user active, divide sixty minutes by the WCT. As mentioned above, each unit value of concurrency factor (CF) is equal to one user active in any one-minute interval. Hence, the maximum workload a network 100 can support before exceeding the network's capacity threshold is the concurrency factor (CF) value times sixty minutes divided by WCT.

For example, if WCT is two minutes, then the maximum WUs per hour for a CF value of one is thirty (i.e., 60/2). If network's concurrency factor (CF) value equals ten, then three hundred WUs per hour can be supported. A question for delivery of an application in a production network is how many workstations are required to generate 116 WUs, which is addressed herein below.

The following text under step 202 describes a general application classification as it relates to the workload. It is helpful to ask two questions when attempting to establish the application's workload with respect to the number of workstations deployed.

1. What category does the application fall in?

2. What is the expected workload per hour for the power user within the top ten users?

Typically, users are separated into three classes:

1. Casual users

2. Standard users

3. Data Entry users

The class of an application user can be identified by the total amount of time, over one hour, that the power user (i.e., a strong user in the class) spends executing the application. Reasonable classifications of time for a power user in each class include:

1. Casual: The power user executes from 0 to 10 minutes (5 minutes mid-point).

2. Standard: The power user executes 10 to 30 minutes (20 minutes mid-point)

3. Data Entry: The power user executes 30 to 50 minutes (40 minutes mid-point)

The purpose of the application 112 and its usage pattern help to identify and establish a conservative estimate for the power user. The average number of WUs executed by the power user, in one hour, can be established using the application's work unit completion time (WCT). For example, if the mid-point is identified as a conservative value for the application's power user, and if the application's WCT is two minutes, then:

1. In a casual user type application, the power user will average 2.5 WUs per hour.

2. In a standard user type application, the power user will average 10 WUs per hour

3. In a data Entry user type application, the power user will average 20 WUs per hour

In the preferred embodiment of the present invention, the applications 112 tested fell within the standard user class, and most fell in the general area of the mid-point with some applications on the low and high limits.

The following text under step 202 describes estimating a base workload. Once the power user's workload is specified, the base workload (BWL) can be established. The BWL is defined by number of WUs per hour averaged over the top-ten user workstations. The BWL is then used to estimate total workload when additional user workstations are added to the top-ten. Preferably, the application's BWL is not customer specific, which would be difficult to determine, and would risk over-sizing or under-sizing network capacity requirements.

To establish the BWL after setting the power user's workload, the total average workload for the top-ten users is estimated. Dividing this value by ten gives the BWL, which is the average number of WUs per top-ten user. The total average workload for the top-ten users can be conservatively established, based on the power user's workload. The total average workload is determined as follows:

Total Workload=(10×Power User's Workload)/2

For Example, if the power user averages ten WUs per hour, then:

Total Workload=(10×10)/2=50 WU's per hour, and BWL=50/10=5 WUs per top-ten users.

The BWL is used to establish the total workload when additional user workstations, beyond the top ten, are being deployed. A short cut formula for BWL is:

BWL=Power User Workload/2.

The following text under step 202 describes the workload and user workstation deployment. As additional users beyond the top-ten are added to the network, the total workload increases in a non-linear manner. Typically, adding ten more users to the top-ten will not double the workload. Using a conservative estimate for the total workload is important when determining the network capacity requirements for a specified number of workstations. On a LAN, this is normally not an issue, but on a WAN this becomes significant because of the size difference between the LAN and the WAN. In the preferred embodiment of the present invention, the BWL for the applications tested are reasonably conservative and applicable for all users of the application. Hence, there is a low probability of severe over-estimating or under-estimating the WAN capacity using the BWL.

Both the NGE 115 and NLE 116 estimate the total workload as follows.

Total Workload=BWL×AWS/LOG (AWS), wherein

AWS is the total number of Active Workstations (i.e., workstations Logged-In), and

the LOG to the base 10 functions produces a gradual reduction in the growth of total workload as additional users are added. This logarithmic function is a very conservative modification to linear growth.

For example, if BWL=5 WUs per hour (this is an average for the top-ten users), and if AWS=10, then

Total Workload=5×10/LOG (10), or

Total Workload=5×10/1=50 WUs per hour (i.e., top-ten user workload)

By a second example, if BWL=5 WUs per hour, and if AWS=20, then

Total Workload=5×20/LOG (20), or

Total Workload=5×20/1.3=76.9 WUs per hour.

In contrast to the second example, linear growth would result in 100 WUs per hour.

By a third example, if BWL=5 WUs per hour, and if AWS=200, then

Total Workload=5×200/LOG (200), or

Total Workload=5×200/2.3=434.8 WUs per Hour

In contrast to the third example, linear growth would result in 1000 WUs per hour.

The total number of work hours completed in the one hour period by all active users is equal to the total workload times the application's WCT (WU Completion Time) divided by 60 minutes.

For example, in the third example of 200 users above, if the WCT=2 minutes, then

Work Hours (WH)=434.8×2 minutes/60 minutes=14.5 hours of work.

If the application's concurrency factor (CF) value for the network is equal to or greater than 14.5, then the network can support the workload without exceeding the network's threshold capacity.

The following text under step 202 describes a process for estimating the number of active users. The formula for total workload requires the number of active users (i.e., logged-in users). The following description determines how active user workstations relate to the total number of deployed workstations. Preferably, the following predetermined algorithm is used: if the deployed workstations are less than or equal to forty, then the active users equals deployed users. However, if the deployed workstations are greater than forty, then the active users are gradually reduced. The need to make the gradual reduction is because the number of log-ins does not increase in a linear manner with an increase in deployed workstations. When the deployed workstations are greater than forty, the following formula is used.

Active Users=Deployed Users×1.6/LOG (Deployed Users)

For example, if Deployed Users equals 100, then

Active Users=100×1.6/LOG (100)=100×1.6/2=80 (i.e., 80%) Active Users.

In a second example, if Deployed Users equals 1000, then

Active Users=1000×1.6/LOG (1000)=1000×1.6/3=533 (i.e., 53%) Active Users.

Preferably, the testing in step 202 is performed in a simulated network environment representing anticipated networks that may use the application. Preferably, a manufacturer (or an approved third party) of an application performs the network load testing on the application in the simulated production environments to generate the network load metrics before the application is shipped to, or sold to the end user, as a computer readable storage medium. The computer readable storage medium includes, without limitation, a magnetic disk or tape, an optical disk such as a computer read only memory (CDROM), a hard drive, and data delivered over a communication path, such as a phone line, the Internet, a coaxial cable, a wireless link, and the like. The simulations may be simple or complex as the anticipated production environments and anticipate end user considerations require to generate few or many, respectively, network load metrics. The task of generating many network load metrics may employ various analytical methods, such as statistics, to providing near continuous network load metric points, without physically running the application in each simulated network environment. Further, the many network load metrics may be predetermined and stored in a database or pre-characterized and represented by equations having input and output variables. Preferably, the network load metrics, or their representative equations, are incorporated with the application's set up files. Then, a network administrator uses the network load metrics for one of the simulated network environments that is closest to the actual production environment. Alternatively, the network administrator may input the characteristics of the actual production network environment into an input window, associated with the set up files, and the set up program provides the end user with recommended network load metrics to be used.

At step 203, the network load estimator (NLE) 116 estimates network load for one or more applications 112 concurrently operating in a production network 100 responsive to the network load metrics determined by the NGE 115 for each of the one or more application.

The NLE 116 uses the application's network load factor and work unit completion time to estimate how many user workstations can be deployed on a WAN. The NLE 116 aggregates the metrics for a large number of different applications 112 allowing it to quickly estimate the WAN's capacity requirements when deploying more than one type of application. The NLE 116 supports complex WAN topologies and aggregates the effects of network load and latencies, thus integrating the impact of multiple applications sharing a WAN. The NLE's inputs come from the NGE 115, and allow a relatively unskilled administrator to work with many different applications in a shared production network environment. By contrast, the NGE 115 only specifies the network profile characteristics of a single application.

Each application 112 in the NLE 116 contains three network load parameters. These parameters are obtained from the NGE 115 when the application 112 profiling process is completed. The three parameters are:

1. Application's CF, (Concurrency Factor) specified for a predetermined (e.g.,128 kbits per second) WAN.

2. Application's BWL (Base Workload).

3. Application's WCT (Workload Completion Time).

To initialize the NLE 116, the administrator configures the WAN speed, selects an application 112, and inputs the number of deployed workstations. The NLE 116 uses the load parameters for the application 112 and the formulas, discussed above, to calculate network capacity used for a specified WAN speed. If more than one application 112 is deployed the NLE 116 will calculate the total capacity used by all the applications 112.

The following process summarizes the NLE calculation process:

1. Calculate the number of active workstations.

If Deployed Workstations>40, then

AWS=(Deployed Workstations×1.6)/LOG (Deployed Workstations).

2. Calculate the Total Workload.

Total Workload=BWL×AWS/LOG (AWS)

3. Calculate the Total Work Hours.

Total Work Hours=Total Workload×WCT/60

4. Calculate the WAN capacity required (bandwidth usage).

Capacity Required=Total Work Hours/CF.

If the Capacity Required>1, then a higher speed WAN is required.

If the Capacity Required=1, then the bandwidth usage is at the WAN's threshold.

WAN Bandwidth Usage=Threshold×Capacity Required.

For example, if CF=20, Total Work Hours=10, and WAN threshold=60%, then WAN Bandwidth Usage=0.5×60%=30%.

Together steps 202 and 203 describe a method for operating a system 101 for estimating network load. The system 101 includes the NGE 115 and the NLE 116, shown in FIG. 3. The NGE 115 analyzes a network load for each software application 112 operating in a simulated network 100 to determine network load metrics for each software application 112. The NLE 116 estimates a network load for one or more software applications 112 concurrently operating in a network 100 responsive to the network load metrics of each software application 112.

Preferably, the NGE 115 analyzes the network load for each software application 112 while operating in a simulated network, such as when a manufacturer of the software application 112 performs the analysis by the NGE 115. In the manufacturer case, the network load metrics for each software application 112 are advantageously provided to a buyer with the software application 112 when purchased by the buyer of the software application 112.

From the perspective of the NGE 115, the NGE 115 is executed within a processor 109 (which employs the NGE 115, the NLE 116, and the NLA 117) to estimate a network load for each software application 112 operating in a network 100 to determine network load metrics for each software application 112. The network load metrics are used by a NLE 116 for estimating a network capacity for one or more software applications 112 concurrently operating in a network 100 responsive to the network load metrics of each software application 112.

From the perspective of the NLE 116, the NLE 116 is executed within a processor 109 to estimate a network capacity for one or more software applications 112 concurrently operating in a network 100 responsive to predetermined network load metrics of each software application 112. The predetermined network load metrics represent a network load for each software application 112 operating in a network 100.

From the perspective of the computer readable storage medium 114, the computer readable storage medium 114 includes an executable application, and data representing network load metrics. The executable application is adapted to operate in a network 100. The data representing network load metrics associated with the executable application 112 is usable in determining a network load representative value for the executable application 112 operating in the network 100. Preferably, the network load metrics are adapted to be used by a NLE 116 for estimating a network capacity for one or more executable applications 112 concurrently operating in a network 100 responsive to the network load metrics.

The network load metrics preferably include at least one of: (a) an estimated average number of bytes transferred in a time interval using the application, (b) an estimated maximum number of bytes transferred in a time interval using the application, (c) an estimated minimum number of bytes transferred in a time interval using the application, (d) a client's average network load factor, (e) an average data packet size, (f) an average number of request/response pairs in an application transaction, and (g) an average number of bytes transferred between a client and at least one server when executing an application transaction. Average values can refer to median, arithmetic mean, or arithmetic mean adjusted to a specified confidence level. The last type accounts for the degree of distribution in the samples when calculating the mean. The value of the mean is increased if the sample distributions are large and/or the confidence is high (for example 95%+).

At step 204, a network load analyzer (NLA) 117 analyzes the network load for the one or more application operating in the production network 100 to measure the actual network load for the one or more applications. Because the NGE 115 and the NLE 116 both provide an estimated network load, the NLA 117 measures the actual network load to determine if the estimated network load is accurate. Preferably, the NLA 117 should be run whenever the conditions of the network 100 substantially change.

At step 205, a determination is made whether the actual network load measured at step 204 matches the estimated network load determined in step 202 or step 203. If the determination at step 205 is positive, then the process 200 continues to step 207; otherwise, if the determination at step 205 is negative, then the process 200 continues to step 206. Preferably, the determination at step 205 is performed manually, but may be performed automatically, if desired.

At step 206, the estimated network load is modified in step 202 or step 203. Preferably, the determination at step 206 is performed manually, but may be performed automatically, if desired. Preferably, the estimated network load using the NLE 116 for each production network is modified responsive to the actual network load measured by the NLA 117. However, because individual production networks may vary, the NLA 117 from multiple production networks modifies the estimated network load using the NGE 115 based on the simulated network responsive to actual network load measurements.

At step 207, the process ends.

FIG. 3 illustrates a timing diagram 300 for an application baseline profile in a test network 100, as shown in FIG. 1, in accordance with a preferred embodiment of the present invention. The timing diagram 300 generally includes a work unit (WU) network trace file 301, a task network trace file 302, and a work unit (WU) flow 303. The term trace file is otherwise called a traffic file.

The work unit (WU) network trace file 301 has time duration 304 (e.g., 2 minutes), otherwise called work unit (WU) completion time, including a start time 305 (e.g., time (T)=0 seconds) and an end time (e.g., time (T)=120 seconds).

The work unit (WU) flow 303 includes a plurality of individual tasks (e.g., task one 307, task two 308, task three 309, and task four 310), wherein user actions, represented as user typing time and thinking time 311, 312, 313, separates adjacent tasks (e.g., time 311 separates task one 307 and task two 308). The work unit (WU) flow 303 represents one function of the application 112. Hence, a user using the application 112 at a workstation performs multiple work unit (WU) flows 303.

In the work unit (WU) flow 303, the size of each task varies depending on the type of task (e.g., task one 307 is 10 Kbytes, task two 308 is 20 Kbytes, task three 309 is 5 Kbytes, and task four 310 is 30 Kbytes). For the work unit (WU) flow 303, the work unit network trace file 301 captures, during the two minute time duration, total data traffic of 65 Kbytes (i.e., 10+20+5+30) between the workstation 102-104 and the server 101.

In the work unit (WU) flow 303, the time duration for each user typing time and thinking time also varies depending on the amount of time required. Each task has a beginning, representing when the task starts, and an end, representing when the task stops. The time duration between the beginning and the end of a task represents a response time for the task. Preferably, the beginning of a task starts at the end of the previous user typing time thinking time, and the end of a task stops at the beginning of the next user typing time thinking time.

Preferably, each work unit network trace file 301 has a defined format, which corresponds to the network's physical configuration, as shown in FIG. 1. For example, the network's physical configuration may have three distinct computer devices that transfer data traffic over the communication path 106 including: 1) client workstation (CW) 102-104, 2) application server (AS) 101 that runs the business logic software, and 3) a database (DB) 113 that stores the application's data. Preferably, there are two traffic flows for this physical configuration including: a first flow from the client workstation 102-104 to the application server 101 and a second flow from the application server 101 to the database 113.

The format of the work unit network trace file 301 corresponding to the network's physical configuration, as shown in FIG. 1, is described in Table 1.

TABLE 1

| | | | | | Measured | |
|---|---|---|---|---|---|---|
| | | | | | WU | Number |
| WU | Node 1 | Node 2 | Node 1 | Node 2 | Completion | of |
| Name | Name | Name | Byte Size | Byte Size | Time | Tasks |
| ABC | CW | AS | 2,000 | 8,000 | 2 minutes | 10 |
| | AS | DB | 5,000 | 12,000 | | |

In Table 1, preferably, the work unit (WU) name, as shown in column one, and the names for node one and node two, as shown in columns two and three, are determined before the work unit network trace file 301 starts. The work unit network trace file 301 captures and records the last four columns (i.e., columns 4, 5, 6 and 7) of data. For example, the work unit (WU) name “ABC,” as shown in column one, has the two traffic flows, wherein each traffic flow includes the amount of data sent in each direction. For example, node one byte size field in column four shows that the client workstation (CW) 102-104 transferred 2,000 bytes to the application server (AS) 101, and that application server (AS) 101 transferred 5,000 bytes to the database (DB) 113. Likewise, for example, node two byte size field, as shown in column five, shows that the application server (AS) 101 transferred 8,000 bytes to the client workstation (CW) 102-104, and that the database (DB) 113 transferred 12,000 bytes to the application server (AS) 101. The measured work unit (WU) completion time 304, as shown in column six, is the total time it takes to execute the work unit flow 303 from beginning 305 to end 306. The number of tasks, as shown in column seven, specifies the number of application tasks executed to complete the work unit flow 303. The NGE 115 uses the recorded information from these four columns (i.e., columns 4, 5, 6 and 7) to perform task analysis validation.

Table 1 may optionally include the total number of frames, corresponding to the bytes sizes, transferred between each platform pair and/or the total number of work unit flows 303.

The task network trace file 302 includes a plurality of individual network trace files, wherein each network trace file corresponds to each task. For example network trace files 314, 315, 316, and 317 correspond to task one 307, task two 308, task three 309, and task four 310, respectively. The task network trace file 302 captures the data traffic associated with individual tasks from start time of each task execution to each task completion time (i.e., the task's response time). In FIG. 3, four task network trace files 302 define the work unit at the task level. Therefore, each complete work unit network trace file 301 has an associated set of task network trace files 302.

The format of the task network trace file 302 corresponding to the network's physical configuration, as shown in FIG. 1, is described in Table 2.

TABLE 2

| | | | | | | | | Measured |
|---|---|---|---|---|---|---|---|---|
| | | | Node 1 | Node 2 | | | | Task |
| Task | Node 1 | Node 2 | Byte | Byte | Node 1 | Node 2 | Number | Response |
| Name | Name | Name | Size | Size | Frames | Frames | of Turns | Time |
| Task 1 | CW | AS | 500 | 4,000 | 5 | 10 | 5 | 2 seconds |
| | AS | DB | 2,000 | 8,000 | 6 | 18 | 20 | |

In Table 2, the field in column one represents the name of the task being performed, as compared to the work unit (WU) being performed in column one of Table 1.

Columns two through five in Table 2 represent the same fields as columns two through five in Table 1. For example, node one byte size field in column four shows that the client workstation (CW) 102-104 transferred 500 bytes to the application server (AS) 101, and that application server (AS) 101 transferred 4,000 bytes to the database (DB) 113. Likewise, for example, node two byte size field, as shown in column five, shows that the application server (AS) 101 transferred 4,000 bytes to the client workstation (CW) 102-104, and that the database (DB) 113 transferred 8,000 bytes to the application server (AS) 101.

The node 1 frames and node 2 frames, as shown in columns six and seven, provides captured information that represents the number of network data frames required to transfer the corresponding data recorded under node one byte size and node two byte size, as shown in columns four and five, respectively. For example, node one frames field in column six shows that it took five frames to transfer 500 bytes from the client workstation (CW) 102-104 to the application server (AS) 101, and that it took six frames to transfer 4,000 bytes from the application server (AS) 101 to the database (DB) 113. Likewise, for example, node two frames field, as shown in column seven, shows that it took ten frames to transfer 4,000 bytes from the application server (AS) 101 to the client workstation (CW) 102-104, and that it took eighteen frames to transfer 8,000 bytes from the database (DB) 113 to the application server (AS) 101.

The number of turns field, as shown in column eight, provides captured information that represents the number of request/response pairs used by node one and node two to transfer the data specified byte size.

The measured task response time, as shown in column nine, is the time measured from when the task is executed to when the task is completed.

Table 2 may optionally include a column indication the total number of tasks.

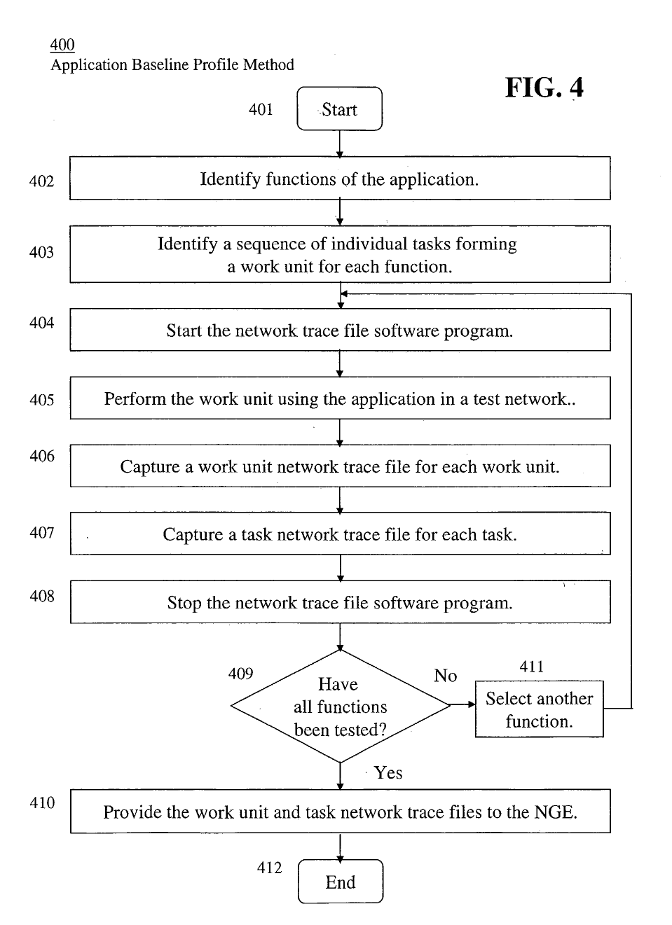

FIG. 4 illustrates a method 400 for determining the application baseline profile, using the timing diagram 300 shown in FIG. 3, in accordance with a preferred embodiment of the present invention. The application baseline profile generally includes the work unit trace files 301 and the task network trace files 302. The network guidelines estimator (NGE) 115 uses files 301 and to determine the network load metrics for the application 112.

At step 401, the method 400 starts.

At step 402, various functions of the application 112 are identified, either automatically and/or manually. Preferably, a person, familiar with the functions of the application 112, manually performs step 402. The identified functions represent typical functions performed by the application 112.

At step 403, a sequence of individual tasks 307-310 forming a work unit flow 303 for each function is identified, either manually and/or automatically. Preferably, a person, familiar with the functions of the application 112, manually performs step 403. For example, a hospital administration application would have one or more work unit flows 303 to admit a patient into the hospital.

At step 404, the network trace file software program is started, either automatically and/or manually. Preferably, the network trace file software program automatically performs step 404. Preferably, the network trace file program is a conventional third party software tool, such as for example, Compuware's Application Expert.

At step 405, the work unit flow 303 using the application 112 in a test network 100 is performed, either automatically and/or manually. Preferably, a person, familiar with the functions of the application 112 and acting as a typical user of the application at a workstation 102-104, manually performs step 405. The person's performance of each work unit flow 303 in the test network 100 represents a production user's performance of the application 112 in a production network. For example, the person, emulating a hospital admissions person, performs the sequence of tasks to complete a patient admission process during an average number of minutes.

At step 406, the network trace file software program captures the work unit (WU) network trace file 301 for each work unit flow 303, either automatically and/or manually. Preferably, the network trace file software program automatically performs step 406. The work unit network trace file 301 inherently contains a complete profile of all user actions performed including the user's thinking time and typing time. The sum of all work unit flows 303 provides the NGE 115 with data to determine the application's network load profile. The application's network load profile is a metric of the application's network capacity requirements.

At step 407, the network trace file software program captures the task network trace file 302 for each task 307-310, either automatically and/or manually. Preferably, the network trace file software program automatically performs step 407. The task network trace files 302 provide the NGE 115 with data to estimate the average task metrics of the application 112. The processor 109 uses the average task metrics to determine the average network latency and specific network latency for each individual task. These metrics help to determine the application's baseline performance profile.

At step 408, the network trace file software program stops, either automatically and/or manually. Preferably, the network trace file software program automatically performs step 408.

At step 409, a determination is made as to whether all of the identified functions of the application 112 been tested, either automatically and/or manually. If the determination at step 409 is positive, then the method continued to step 410; otherwise, if the determination at step 409 is negative, then the method continues to step 411. Preferably, a person, familiar with the functions of the application 112, manually performs step 409.

At step 410, the work unit trace files 301 and the task network trace files 302 are provided to the network guidelines estimator (NGE) 115, either automatically and/or manually. Preferably, a person manually makes a connection for the work unit trace files 301 and the task network trace files 302 to be provided to the NGE 115. However, once connected, the work unit trace files 301 and the task network trace files 302 are automatically transferred to the NGE 115 using an electronic communication protocol.

At step 411, another identified function of the application 112 is selected, either automatically and/or manually. Preferably, a person, familiar with the functions of the application 112, manually performs step 409. The method 400 continues until all if the identified functions have been performed and corresponding files captured. After step 411, the method 400 returns to step 404, wherein the network trace file software program is started again.

As noted above, each of the steps of the method 400, except for steps 406 and 407, may be performed either manually and/or automatically, depending on such engineering, business, and technical factors as the type, construction, and function of the application 112, the number of applications 112 to be tested, the cost to automate the testing, the cost to perform the method manually, the reliability of manual testing, and the like. A person familiar with the purpose and operation of method 400 performs the manual operations. A computerized software program programmed to perform the method 400 performs the automatic operation. A combination of a person and a computerized software program also may perform the method 400 with a combination of manual and automatic, respectively, operations.

At step 412, the method 400 ends.

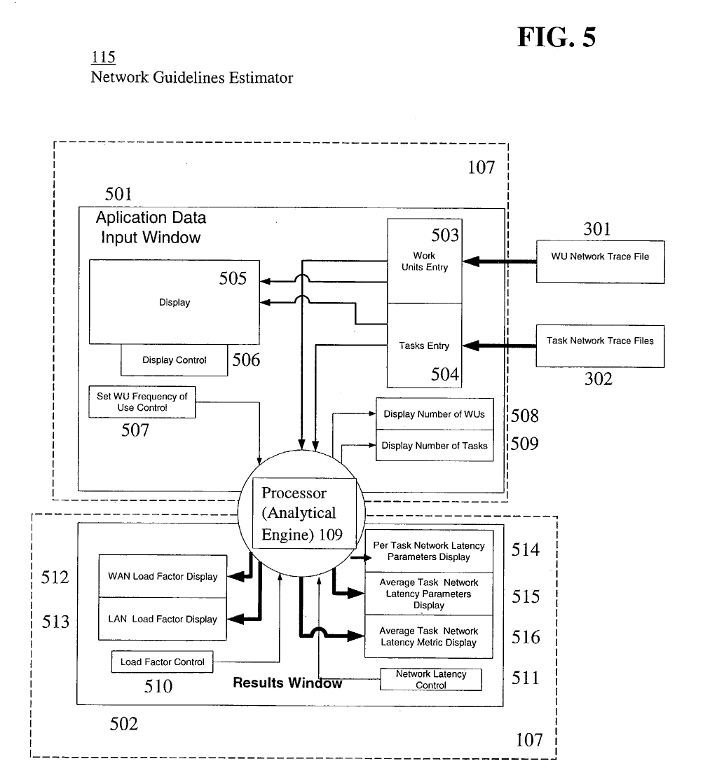

FIG. 5 illustrates a logical diagram for the network guidelines estimator (NGE) 115, as shown in FIG. 1, in accordance with a preferred embodiment of the present invention. The NGE 115 generally includes a user interface 107 electrically coupled to a processor 109, and adapted to receive work unit (WU) network trace files 301 and task network trace files 302. The processor 109 may otherwise be called an analytical engine.

The user interface 107 generally includes an application data input window 501 and a results window 502. The application data input window 501 includes a work unit's entry interface 503, a tasks entry interface 504, a display 505 with display control 506, a work unit (WU) frequency of use control input 507, a number of work units (WU) 508, and a number of tasks 509. The results window 502 includes a load factor control input 510, a network latency control input 511, a WAN load factor 512, a LAN load factor 513, a per task network latency parameters 514, an average task network latency parameters 515, and an average task network latency metric 516.

The processor 109 receives the work unit (WU) network trace files 301 and the task network trace files 302 from the network trace file software program via the work units entry interface 503 and the tasks entry interface 504, respectively. The processor 109 determines the number of work units (WU) 508 and the number of tasks 509, responsive to receiving the work unit (WU) network trace files 301 and the task network trace files 302, for presentation on the display 506. The processor 109 receives the work unit (WU) frequency of use control input 507.

The processor 109 generates two primary groups of output data, for presentation on the display 506, including load factor metrics and network latency metrics responsive to receiving the load factor control input 510 and the network latency control input 511, respectively. The load factor metrics include the WAN load factor 512 and the LAN load factor 513. The network latency metrics include the per task network latency parameters 514, the average task network latency parameters 515, and the average task network latency metric 516. The load factor metrics and network latency metrics help to specify two network characteristics for the application including a network bandwidth capacity and a network performance capability. Theses values are computed averages of the work unit (WU) network trace files 301 and the task network trace files 302.

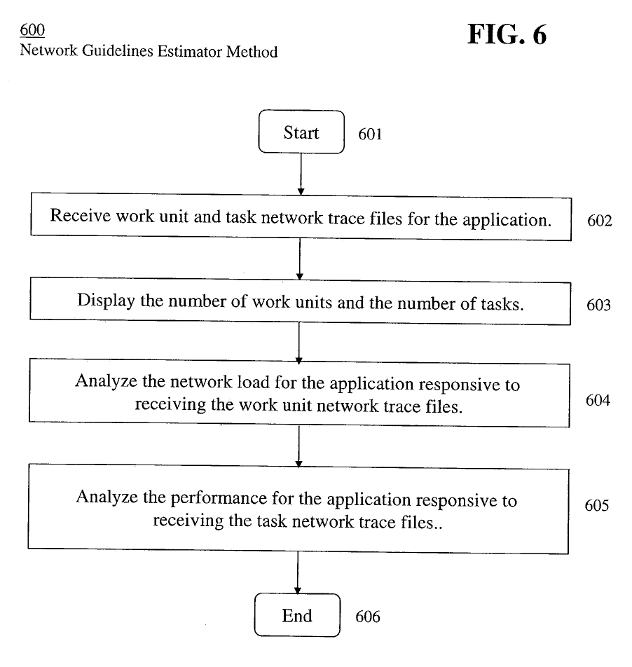

FIG. 6 illustrates a method 600 for estimating a network load for an application 112 operating in the test network 100, as shown in FIG. 1, using the network guidelines estimator (NGE) 115, as shown in FIG. 1, in accordance with a preferred embodiment of the present invention.

At step 601, the method 600 starts.

At step 602, the NGE 115 receives the work unit network trace files 301 and the task network trace files 302 from the network trace file software program.

At step 603, the NGE 115 displays the number of work units 508 and the number of tasks 509 using the output device 110, preferably in the application data input window 501. The display control 506 permits a network analyst operating the NGE 115 to review the work units 508 and/or the tasks 509 in the application data input window 501.

At step 604, the NGE 115 estimates the network load for the application 112 responsive to receiving the work unit network trace files 301 to determine network load metrics for the application 112. A detailed example of step 604 is described in the following text.

The analyst specifies what application traffic flow that will be analyzed for transfer over the network. For the example, the NGE may be used to baseline profile the application for operating client workstations (CW) over a WAN or LAN. Preferably, by default, the NGE 115 provides LAN network load analysis for all traffic flows.

The load factor control 510 in the results window 502, as shown in FIG. 5, specifies the application device(s) that will run over a WAN by entering the appropriate name(s), specified in the work unit network trace file 301. The WAN bandwidth (i.e., data rate) is also selected from a list of WAN data rates. The user can also select or use default bandwidth values for the WAN and the LAN. Preferably, the default bandwidth values for the WAN and the LAN is 60%. These default bandwidth values and an estimated load factor are used to specify the number of concurrent client workstations 102-104 that will consume an average 60% WAN or LAN bandwidth. Preferably, the allowable bandwidth (ABW) value for the LAN is set to 20%.

The work unit (WU) frequency of use control 507 in the application data input window 501, as shown in FIG. 5, specifies how the set of work unit (WUs) are weighted when the NGE 115 calculates the average load factor (LF) and average work unit completion time (WTC). Preferably, the default weighting is uniform weighting. When selection is made, the NGE 115 displays in the WAN display 512 and the LAN display 513 the result window 502, as shown in FIG. 5, the following four network load metrics.

i. 1. Load Factor (LF). This metric specifies the amount of network bandwidth used by an application platform (client workstation, database server etc), when one user is actively executing application work unit flows 303. The NGE 115 calculates, for each application platform, one load factor metric for application platforms that will use a LAN and one value for application platforms that will use a WAN. Client workstations 102-104 are typically identified as using WANs. The average network bandwidth is calculated using the mean, variance, and number of tasks.

2. Concurrency Factor (CF). This metric specifies the number of concurrent users that will consume the network's available bandwidth. This metric is related to the load factor (LF) and the allowable bandwidth (ABW). The NGE 115 computes the CF by dividing the LF into the ABW.

3. Work Unit Completion Time (WCT). This metric is the average time required to complete the execution of work units.

4. Workload (WL). This metric specifies the average number of work units that can be executed in a predetermined period of time (e.g., one hour) without exceeding a predetermined allowable bandwidth (ABW). Dividing sixty (60) minutes by work unit completion time and multiplying the resultant value by the concurrency factor calculates workload.

The network's physical configuration includes three types of devices, as follows:

1. Client workstation (CW). The users execute the work units on the client workstation 102-104.

2. Application Server (AS). The application server 101 runs the application's code to process the client workstation's requests.

3. Database (DB). The database 113 provides the data to application server 101 during the execution of the work unit.

The traffic flows between the devices are as follows:

CW←WAN→AS←LAN→DB

Preferably, the bit rates (i.e., bandwidth) for the WAN and the LAN are as follows:

1. WAN has a bit rate of 128,000 bits/sec.

2. LAN has a bit rate CW to AS of 100,000,000 bits/sec.

3. LAN has a bit rate AS to DB of 100,000,000 bits/sec

Based of analysis of the work unit trace files 301, the NGE 115 calculates the following analysis for the WAN:

1. CW's WAN LF=2%. This indicates that a single client workstation 102-104 will consume 2% of the WAN capacity when actively executing an application work unit flow 303.

2. CW's WAN CF=30@ABW of 60%. This indicates that when thirty client workstations 102-104 are actively executing work unit flows 303, the WAN will be loaded at an average of 60%.

3. WCT=2 minutes. This is the average time to complete a work unit flow 303. The NGE 115 calculates this value using information received from the work unit trace files 301.

4. WAN's WL=900. This indicates that the WAN will support the execution of 900 work units per hour at 60% load.

Preferably, the format of the display output in the WAN display 512, as shown in FIG. 5, is shown in Table 3.

TABLE 3

| WAN | Allowable | | | | | Average WU |
|---|---|---|---|---|---|---|
| Bandwidth | Bandwidth | Application | LF | | WL | Completion Time |
| Bits per sec | % | Device Name | % | CF | WU/Hr | Minute |
| 128,000 | 60 | CW (Client Workstation) | 2 | 30 | 900 | 2 |

Based of analysis of the work unit trace files 301, the NGE 301 calculates the following analysis for the LAN:

1. CW's LAN LF=0.03%.

2. CW's LAN CF=667@ABW of 20%.

3. AS/DB LAN LF=0.01%.

4. AS.DB LAN CF=6000@ABW of 60%.

5. WCT=2 minutes.

6. CW's LAN's WL=20,010.

7. AS/DB LAN's WL=180,000.

Preferably, the format of the display output in the LAN display 513, as shown in FIG. 5, is shown in Table 4.

TABLE 4

| | | | | | | Average WU |
|---|---|---|---|---|---|---|
| LAN | Allowable | | | | | Completion |
| Bandwidth | Bandwidth | | LF | | WL | Time |
| Bits per sec | (%) | Application Device Name | % | CF | WU/Hr | Minute |
| 10,000,000 | 20 | CW/AS | 0.03 | 667 | 20,010 | 2 |
| 100,000,000 | 60 | AS/DB | 0.01 | 6000 | 180,000 | 2 |

At step 605, the NGE 115 estimates the performance of the application 112 responsive to receiving the task network trace files 302 to determine network performance parameters for the application 112. A detailed example of step 605 is described in the following text.

The NGE 115 uses the task network trace files 302 to calculate performance metrics for the application 112. Preferably, the task analysis and the computed metrics are only applied to a WAN, where performance is a prime issue. The NGE 115 calculates the average task metrics for the application device(s), typically client workstations 102-104, that will transfer traffic over a WAN. The NGE 115 uses the WAN configuration applied during the network load analysis to analyze the performance of the application 112.

The average task network latency parameters display 515, as shown in FIG. 5, shows the NGE's analysis of the task network trace files 302. The average task network latency parameters specify the average values for all task network trace files 302. Preferably, the average task network latency parameters are calculated using the mean, variance, and number of tasks. Preferably, the average task network latency parameters relate to the application's performance over a WAN. The NGE 115 displays the average task network latency parameters as soon as the network load analysis, described under step 604, starts.

The NGE 115 checks the validity of the average task network latency parameters by comparing the task network load factor with the load factor calculated using the work unit trace files 301. The NGE 115 accomplishes this comparison by first estimating the average task size based on the task network trace files 302. The average task size is multiplied by the average number of tasks executed per minute, which is provided by the NGE 115 and derived during the network load analysis, described under step 604. The average number of tasks per minute is set by the NGE 115 and is based on the work unit trace files 301. If the task load factor is within ninety five percent (95%) of the work unit based load factor, task analysis is considered valid or acceptable. Alternatively, the NGE 115 determines that the task analysis is invalid when the task network trace files 302 are inconsistent with the work unit network trace files 301. An invalid indication from the NGE 115 may indicate that task network trace files 302 captured during application baseline profile testing were incorrect. In this case, the task network trace files 302 would need to be rerun under valid conditions. However, the NGE analyst may override the 95% comparison value to estimate the degree of error, and elect to accept the larger error and permit the NGE 115 to generate the performance parameters.

The performance parameters related to the task analysis are provided as follows:

1. Average Task Size. This parameter represents the average number of data bytes transferred over a WAN when a client workstation 102-104 executes a task. The size is displayed for each communication direction. This parameter is used to estimate the average WAN insertion delay component of network latency.

2. Average Number of Turns. This parameter represents the average number of request/response pairs that are exchanged between client workstation and server when executing a task. This parameter is advantageous for determining a WAN propagation delay component of network latency and its contribution to task network latency.

3. Average Number of Data Frames. This parameter represents the number of network data frames required to transfer data for a task specified by the average task size. This parameter is used to estimate a WAN queue delay component of network latency.

4. Average Base Response Time. This parameter represents the average time to complete a task when the task network trace files 302 were captured during the application profile testing. This parameter relates primarily to the processing delays in the application hardware components. The total response time when the client workstations 102-104 operates over a WAN is estimated by adding this parameter to the NGE's network latency estimate.

These four performance parameters are used to calculate the application's average task network latency metrics, as discussed herein below.

Preferably, the format of the average task network latency parameter display 515, as shown in FIG. 5, is shown in Table 5.

TABLE 5

| Average | | | Average Data | Average Data | |
|---|---|---|---|---|---|
| Task Size | Average Task | | Frames | Frames | Average |
| Up-Stream | Down-Stream | Average Turns | Up-Stream | Down-Stream | Base RT |
| 1,000 Bytes | 6,000 Byes | 10 | 4 | 12 | 2 sec |

The network latency control 511 in the results window 502, as shown in FIG. 5, specifies the WAN conditions to be used for network latency analysis to produce average task network latency metrics shown in display 516, as shown in FIG. 5. The NGE 115 controls the analysis for the average task network latency metrics to determine the application's network performance profile responsive to the following WAN conditions.

1. The WAN bandwidth for average network latency analysis and metrics. The user inputs the bandwidth values in Kbits per second for both communication directions.

2. The WAN distance in miles.

3. The WAN's background load. The percentage of WAN capacity used to represent other user activity on the WAN (i.e., bandwidth consumed by unknown applications). The value is preferably set to 60%.

4. The type of WAN (e.g., dedicated line, dial-up, frame relay, ATM, etc.) Preferably, the format of the average task network latency metrics display 516, as shown in FIG. 5, is shown in Table 6.

TABLE 6

| WAN | | | | WAN | | | Network |
|---|---|---|---|---|---|---|---|
| Bandwidth | | WAN | Insertion | Background | Propagation | Queue | Response |
| (Kbits per | WAN | Distance | Delay | Load | Delay | Delay | Time |
| sec) | Type | (Miles) | (sec) | % | (sec) | (sec) | (sec) |
| 128 Kb | Dedicated | | | | | | |
| | | 50 | 0.87 | 0 | 0.1 | 0 | 0.97 |
| | | 3000 | 0.87 | | 0.8 | 0 | 1.67 |
| | | 50 | 0.87 | 60 | 0.1 | 1.0 | 1.97 |
| | | 3000 | 0.87 | 60 | 0.8 | 1.0 | 2.67 |

In Table 6, the network's response time added to the application's base response time equals the average total response time for the application's average task.

The NGE 115 uses the network latency control 511 to perform a per task performance analysis, as shown in display 514 in FIG. 5, and to setup the WAN conditions for an analysis report. The per task performance analysis uses the same WAN conditions as for the average network performance analysis described herein above. However, the per task performance analysis may also use multiple WAN bandwidths to provide an easy comparison for how higher WAN bandwidths may perform.

The NGE calculates the network latency metrics and task parameters for every specific task received from the task network trace files 302 to determine per task network parameters. Preferably, a user can scroll through the analysis results in the per task display 514 to permit the user review of the performance of any specific task using the per task display 514. The user can also execute a formatted printout of the results for all tasks.

Preferably, the format of the per task network latency display 514, as shown in FIG. 5, is shown in Table 7.

TABLE 7

| | | | | | WAN BW | | | WAN BW | | |
|---|---|---|---|---|---|---|---|---|---|---|
| | | | | | 128 Kbits | | Total | 1536 Kbits | | Total |
| | Task | | | Base | per Sec | | RT | per Sec | | RT |
| Task | Size | # of | | RT | LL | HL | (Sec) | LL | HL | (Sec) |
| Name | (Bytes) | Frames | Turns | (Sec) | (Sec) | (Sec) | HL | (Sec) | (Sec) | HL |
| ABC | 10,000 | 30 | 20 | 1 | 1 | 3 | 4 | .1 | 1 | 2.0 |
| XYZ | 7,000 | 15 | 10 | 2 | 0.5 | 1.5 | 3.5 | .05 | .4 | 2.4 |

In Table 7, the low latency (LL) field represents low propagation delay (e.g., 50 miles at 0% WAN background load). The high latency (HL) field represents high propagation delay (e.g., 3000 miles at 60% WAN background load). The total response time (RT) field represents the task's response time with the base response time (RT) added to the high latency (HL) network latency. Table 7 shows two WAN bandwidths are analyzed to permit comparison between the two bandwidths in case a faster bandwidth is preferred.

Preferably, the network latency control can be used to display only tasks that have a high latency (HL) that exceeds the average network latency by a predetermined value entered by a user of the NGE 115. Using the network latency control in this manner advantageously permits a user to identify a task that may be inhibiting performance when operating over a WAN.

At step 606, the method 600 ends.

In summary of the preferred embodiment of the present invention, the network guidelines estimator (NGE) 115 estimates network load metrics and performance parameters for each application 112 operating in a test network 101 responsive to baseline profile testing of each application 112. The NGE 115 provides an efficient method for establishing an application's baseline profile. Application baseline profile testing 400 includes capturing work flow network trace files 301 and task network trace files 302 while evaluating a test network. The files 301 and 302 may be captured using a conventional third party sniffer tool or using a variety of other conventional methods. The NGE 115 provides network load metrics and performance parameters averaged over all the application functions, without the need to perform application network simulation that applies to a specified network configuration. The network load metrics and performance parameters for an application 112 are advantageously used to evaluate applications, software development, and network capacity planning for any particular network configuration.

The network load estimator (NLE) 116 estimates a network load for one or more software applications concurrently operating in a network responsive to the network load metrics and performance parameters of each software application. The NLE 116 provides an easy to use network simulation tool used to size the network capacity and network latency of networks having a large number of networked applications, without using complex network simulation tools. Users of the NLE 116 do not need any particular knowledge or experience with complex network simulation tools that require hours to setup and run. The user interface is straightforward and easily understood. Analysis results are performed in minutes instead of hours. Performance issues are presented in real-time allowing a user to make fast decisions and changes to sizing the WAN for proper performance. Hence, the NLE 116 permits quick and reliable sizing of WANs when deploying one or more applications simultaneously.

The NLA 117 receives network trace files 301 and 302 that contain captured data traffic generated by workstations 102-104 executing an application in a preferably live production environment. The NLA 117 is then used to digest one or more trace files (each file preferably having fifteen minutes of traffic activity) to produce the application's network capacity profile. The NLA 117 performs analysis of the trace file data, filtered in each sample time window (preferably 60 seconds intervals). Each time window shows the total traffic load, the total number of clients producing traffic, the average traffic load per client (average WAN bandwidth per client), and the client concurrency rate (client workload). All window measurement over all network trace files 301 and 302 are averaged using mean, variance and confidence level to establish the application's capacity profile metrics: 1) client load factor (i.e., bandwidth usage) and 2) client concurrency rate (i.e., workload). These two metrics are used to validate metrics estimated by the NGE 115 that is used to profile the application 112 before general availability release of the application 112 and to validate performance of the production network. Since NLA application analysis is preferably made using traffic from a live application, the NLA metrics provide an accurate and easy method to size a WAN when adding new clients 102-104 to the application 112. The NLA metrics are then used to tune the NLE 116 and/or the NGE 115.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A method for determining network operational characteristics of a software application, the method comprising the steps of:
performing a plurality of functions of a software application in a test network responsive to identifying the plurality of functions of the software application; and
analyzing network operational characteristics of the software application in the test network, responsive to performing the plurality of functions of the software application in the test network, to estimate network operational characteristics of the software application in a production network.

2. A method according to claim 1, wherein the step of analyzing further comprises the steps of:
analyzing network bandwidth characteristics of the software application in the test network, responsive to receiving work unit network trace files, to estimate network bandwidth characteristics for the software application in the production network, and analyzing network latency characteristics of the software application in the test network, responsive to receiving task network trace files, to estimate network latency characteristics for the software application in the production network.

3. A method according to claim 2,
wherein the step of analyzing network bandwidth characteristics further comprises the step of:
capturing a work unit network trace file for each of a plurality of work units of the software application, responsive to performing the plurality of work units, wherein the plurality of work units correspond to the plurality of functions of the software application, and wherein each work unit includes a plurality of tasks; and
wherein the step of analyzing network latency characteristics further comprises the step of:
capturing a task network trace file for each of a plurality of tasks of the software application, responsive to performing the plurality of work units.

4. A method according to claim 3, wherein the network bandwidth characteristics further comprises at least one of:
a load factor representing an average network bandwidth used when a single client workstation is actively performing one of the plurality of work units;
a concurrency factor representing an predetermined bandwidth divided by the load factor;
a work unit completion time representing an average time required to complete the performance of the plurality of work units; and
work load representing an average number of work units that can be performed in a predetermined period of time and within the predetermined bandwidth.

5. A method according to claim 3, wherein the task network trace file for each of a plurality of tasks further comprise at least one of:
a task size representing a number of data bytes transferred over the test network between a client workstation and a server during the performance of one of the plurality of tasks;
a number of turns representing a number of request/response pairs in a task;
a number of data frames representing a number of data frames required to transfer the average number of data bytes in the average task size; and
a base response time representing a time to complete a task.

6. A method according to claim 5, wherein the task size characteristic further comprises:
a first number of data bytes transferred over the test network from the client workstation to the server; and
a second number of data bytes transferred over the test network from the server to the client workstation.

7. A method according to claim 2, wherein the step of analyzing network latency characteristics of the software application in the test network is further responsive to at least one of:
a network bandwidth representing a rate of data transfer between a client workstation and a server;
a network distance representing a physical distance between the client workstation and the server;
a background load representing a rate of data transfer between the client workstation and the server by other software applications; and
a type of network representing a network configuration between a client workstation and a server.

8. A method according to claim 3, wherein the network latency characteristics further comprise at least one of:
an insertion delay;
a propagation delay;
a queue delay; and
a network response time.

9. A method according to claim 3, wherein the network latency characteristics for each task further comprises:
a total response time for each task representing a base response time added to a high network latency.

10. A method for determining network operational characteristics of a software application comprising the steps of:
identifying a plurality of functions of the software application;
identifying a plurality of work units corresponding to the plurality of functions of the software application responsive to identifying the plurality of functions, wherein each work unit includes a plurality of tasks;
performing the plurality of work units using the software application in a test network responsive to identifying the plurality of work units;
capturing a work unit network trace file for each of the plurality of work units responsive to performing the plurality of work units;
capturing a task network trace file for each of the plurality of tasks responsive to performing the plurality of work units;
analyzing network bandwidth of the software application in the test network, responsive to receiving the work unit network trace files, to estimate network bandwidth characteristics for the software application in a production network, and analyzing network latency of the software application in the test network, responsive to receiving the task network trace files, to estimate network latency characteristics for the software application in the production network.

11. Computer readable product comprising:
an executable application adapted to operate in a production network; and
data representing network operational characteristics, associated with the executable application while operating in a test network, adapted for use in estimating network operational characteristics for one or more executable application applications concurrently operating in a production network.

12. Computer readable product according to claim 11, wherein the network operational characteristics further comprise:
network bandwidth characteristics associated with the software application; and
network latency characteristics associated with the software application.

13. Computer readable product according to claim 12, wherein the network bandwidth characteristics further comprises at least one of:
a load factor representing an average network bandwidth used when a single client workstation is actively performing one of the plurality of work units;
a concurrency factor representing an allowable bandwidth divided by the load factor;
a work unit completion time representing an average time required to complete the performance of the plurality of work units; and
work load representing an average number of work units that can be performed in a predetermined period of time and within the allowable bandwidth.

14. Computer readable product according to claim 12, wherein the network latency characteristics further comprise at least one of:
an insertion delay;
a propagation delay;
a queue delay; and
a network response time.

15. Computer readable product according to claim 12, wherein the network latency characteristics for each task further comprises:
a total response time for each task representing a base response time added to a high network latency.

16. A system for estimating an average network load factor identifying an average network bandwidth capacity used in transferring data, from a user workstation executing a first application, to a remote device via said network, comprising:
an interface processor for receiving parameters including,
a first set of parameters derived from captured network data traffic associated with a sequence of tasks performed by a first application executing on a workstation and being conveyed between a server and said workstation, and
a second set of parameters derived from captured network data traffic associated with operation of individual tasks performed in said first application task sequence and conveyed between said server and said workstation; and
a data analyzer for determining an average network load factor of said first application based on said first and said second sets of parameters.

17. A system according to claim 16, wherein
said average network load factor comprises at least one of, (a) an arithmetical mean network load factor of load factors provided for individual tasks of said sequence of tasks and (b) an arithmetical mean network load factor of load factors provided for individual tasks of said sequence of tasks adjusted in response to a standard deviation or variance measure and number of tasks in said sequence of tasks.

18. A system according to claim 16, wherein
said second set of parameters is derived from captured network data traffic associated with a duration of operation of individual tasks between a task start and task completion time.

19. A system according to claim 16, wherein
said workstation comprises a second server.

20. A system according to claim 16, wherein
said first set of parameters derived from captured network data comprises at least two of, (a) number of bytes transferred between each platform pair, (b) number of packets transferred between each platform pair, (c) number of bytes transferred from a first platform pair to a second platform pair, for each platform pair, (d) number of bytes transferred from said second platform pair to said first platform pair, for each platform pair and (e) a time duration of said sequence of tasks.

21. A system according to claim 20, wherein
said platform pair comprises any two devices in said network involved in conveying data traffic associated with said first application.

22. A system according to claim 16, wherein
said second set of parameters are associated with an individual task of said sequence of task and comprise at least two of, (a) number of bytes transferred between each platform pair, (b) number of packets transferred between each platform pair, (c) number of bytes transferred from a first platform pair to a second platform pair, for each platform pair, (d) number of bytes transferred from said second platform pair to said first platform pair, for each platform pair, (e) a time duration of a task, (f) a number of message request corresponding message response pairs occurring between each platform pair, and (g) a number of tasks.

23. A system for estimating average delay in network response attributable to an individual application, comprising:
a data analyzer for determining an estimate of average delay in network response attributable to an individual application based on parameters, associated with said individual application, including:
a first parameter representing an estimated average number of request and response message pairs occurring during operation of said individual application,
a second parameter representing an estimated average data traffic size from a user workstation to at least one server,
a third parameter representing an estimated average data traffic size from said at least one server to said user workstation,
a fourth parameter representing an estimated average data traffic number of packets from said user workstation to said at least one server, and
a fifth parameter representing an estimated average data traffic number of packets from said at least one server to said user workstation; and
an interface processor for processing said determined estimate of average delay in network response for communication to a device in response to user command.

24. A system according to claim 23, wherein
said data analyzer determines said estimate of average delay in network response attributable to said individual application based on user entered parameters including at least two of, (a) network speed, (b) network distance and (c) network background bandwidth capacity usage.

25. A system for generating parameters for use in estimating average delay in network response attributable to an individual application, comprising:
a data analyzer for providing a plurality of parameters by analyzing network data traffic trace files, said plurality of parameters including at least two of,
a first parameter representing an estimated average number of request and response message pairs occurring during operation of said individual application,
a second parameter representing an estimated average data traffic size from a user workstation to at least one server,
a third parameter representing an estimated average data traffic size from said at least one server to said user workstation,
a fourth parameter representing an estimated average data traffic number of packets from said user workstation to said at least one server, and
a fifth parameter representing an estimated average data traffic number of packets from said at least one server to said user workstation; and
an interface processor for providing said plurality of parameters for output in response to a command.
